(19) United States
(12) Patent Application Publication
(10) Pub. No.: US 2007/0272362 A1
(43) Pub. Date: Nov. 29, 2007

(54) Dispensing apparatus for pressure-sensitive adhesive dispensing tape

(75) Inventor: Burton J. Peterson, Waterford, WI (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(73) Assignee: Glue Dots International, LLC

(21) Appl. No.: 11/438,815

(22) Filed: May 23, 2006

(51) Int. Cl. B29C 63/00

(52) U.S. Cl. 156/584

(57) ABSTRACT

A method and apparatus are provided for dispensing pressure-sensitive adhesive segments from a flexible carrier tape, through use of a dispensing apparatus including a dispenser having a substantially rigid wire frame. The dispenser includes a braking apparatus, operatively connected for resisting rotation of a coil of pressure-sensitive adhesive dispensing tape, which includes an array of the adhesive segments attached to the carrier tape. The dispenser also includes an anvil and a guide, for facilitating proper positioning of the coil of tape and reliable transfer of the adhesive segments to a credit card, or the like. The invention is amendable to use in low-volume operations.

### BACKGROUND OF THE INVENTION

### Field of the Invention

The present invention relates generally to the attachment of a card, such as a credit card or the like, to a carrier document so that the card or the like can be peeled easily from the carrier document for use by a consumer, and more particularly to an apparatus for dispensing pressure-sensitive adhesive segments for joining the card or the like to the carrier document in low-volume operations.

Commonly assigned U.S. Pat. No. 6,640,864, to Downs, discloses a method and apparatus allowing thermoplastic pressure-sensitive adhesives to be used simply and safely by those who have low-volume requirements. According to Downs, pressure-sensitive thermoplastic adhesive is pre-metered onto a release strip which may be rolled into a coil. The size and spacing of the metered segments of thermoplastic adhesive allows one adhesive segment to be exposed at a time, across an anvil plate which may be used to press the adhesive segment against a card or the like. The carrier strip may be advanced between the pressing operation to bring a new adhesive segment into position.

Downs discloses an apparatus and methods for dispensing the segments through use of a specially constructed cardboard dispenser box having features which facilitate applications of the pressure-sensitive adhesive segments in low volume applications.

Specifically, in Downs, a coil of thermoplastic adhesive dispensing tape, having a flexible carrier tape extending longitudinally with the thermoplastic adhesive segments arrayed longitudinally along the tape, is inserted into a dispensing container having a generally rectangular configuration, with top, side, and bottom walls and a spanning vertical wall. The vertical wall includes a coil support hub extending laterally into the volume of the container from the vertical wall, about which the coil may be positioned. As positioned, the coil is free to rotate around a horizontal axis, with the outer surface of the coil, on which the adhesive segments are arrayed, being spaced away from the inner surfaces of the top, side, and bottom walls of the dispenser box.

A slot at one end of the upper wall allows a portion of the carrier strip to be threaded from within the container, out of the slot, and across the upper wall in such a manner that the adhesive segments are exposed on the upper surface of the carrier strip. The upper wall provides an anvil surface supporting the carrier strip against pressure when a card or the like is pressed down against the upper surface of the carrier strip to receive an adhesive segment.

As a result of the longitudinal spacing between the adhesive segments on the carrier strip, only a single adhesive segment need be exposed on the upper surface of the container, at a given time, simplifying the attachment process.

The portion of the carrier strip previously having its adhesive segments removed may be received within a slot in a side wall, adjacent the top wall, and then threaded out of a similar slot positioned below the first slot, to permit sliding of the carrier strip longitudinally, for the dispensing of additional adhesive segments, while precluding looseness of the carrier strip in a manner that would permit unintentional unwinding of the coil within the container.

Downs further discloses that such a container may be used for manual dispensing, or may be placed within an automatic dispensing system, including a container sleeve, for holding the lower portion of the container, and a motor drive unit and associated controls for positioning the carrier strip to expose a single adhesive segment at the top of the container.

Although the apparatus and methods of Downs work very well in many applications, further improvement is desirable. Because a coil of thermoplastic adhesive dispensing tape, of the type disclosed by Downs, is often supplied in a form having an outer diameter of 14 inches or greater, and a transverse width of 2 inches or less, the container of Downs is prone to being tipped over sideways, either during or between applications of force to the upper surface of the container, in applications where the container is not supported within a rigid container sleeve holding the lower portion of the container. Also, the repeated application of downward force, on the upper wall of the container, to remove adhesive segments from the carrier tape, can, over time, cause the container to deform in a manner making it more difficult to get the adhesive segments to properly adhere to a card or the like. This is particularly true where excessive force is inadvertently applied, by a careless or inexperienced person.

It is desirable, therefore, to provide an improved method and apparatus for dispensing pressure-sensitive adhesive segments from a release tape, which overcome one or more of the less desirable aspects of the prior art, discussed above.

### SUMMARY OF THE INVENTION

The disadvantages and limitations of the background art discussed above are overcome by the present invention. The invention provides an improved method and apparatus for dispensing pressure-sensitive adhesive segments from a flexible carrier tape, through use of a dispensing apparatus including a dispenser having a substantially rigid wire frame. A dispenser, according to the invention, may also include a braking apparatus, operatively connected for resisting rotation of a coil of pressure-sensitive adhesive dispensing tape including an array of the adhesive segments attached to the carrier tape.

In one form of the invention, an apparatus is provided, for dispensing pressure-sensitive adhesive segments from a flexible carrier tape of a pressure-sensitive adhesive dispensing tape including the flexible carrier tape and the pressure-sensitive adhesive segments. The carrier tape has a transverse tape width and opposed first and second release surfaces. The adhesive segments are arrayed longitudinally along the first release surface. The dispensing apparatus includes a dispenser, which includes a substantially rigid wire frame and an anvil having a tape contact surface thereof adapted for contacting the second surface of the carrier tape. The wire frame of the dispenser includes a base, a reel support, and an anvil support.

The base of the wire frame is shaped for resting on a horizontal surface, and defines longitudinal and transverse frame axes extending substantially parallel to the longitudinal and transverse axes of the carrier tape. The reel support, of the wire frame, is disposed above the base, when the dispenser is oriented as it would be if the base were resting on a horizontal surface, for holding the pressure-sensitive adhesive dispensing tape in a coiled configuration with the first surface of the carrier tape facing outward from the coil. The anvil support, of the wire frame, is disposed above the reel support, and has the anvil attached thereto, with the tape contact surface of the anvil facing upward and oriented substantially horizontally, when the wire frame is oriented as it would be with the base resting on a horizontal surface.

A dispenser, according to the invention, may also include a guide, for receiving the carrier tape after the pressure-sensitive adhesive segments have been removed. The anvil may also include a resilient pad bearing against and/or defining the tape contact surface of the anvil. The tape contact surface may be formed of a material having a low co-efficient of friction. An apparatus, according to the invention, may further include a reel axial operatively attached to the reel support and defining a substantially transversely oriented axis of rotation of the coil configuration of the pressure-sensitive adhesive dispensing tape.

In some forms of the invention, the reel support defines a substantially transversely oriented axis of rotation of the coil configuration of the pressure-sensitive adhesive dispensing tape, and the apparatus further includes a braking apparatus operatively connected to the reel support, for resisting rotation of the coiled configuration of the pressure-sensitive adhesive dispensing tape about the axis of rotation.

A braking apparatus, according to the invention, may include a hub extending through the coiled configuration of dispensing tape, and a reel axle extending along the axis of rotation. The reel axis extends through the reel support and the hub, for supporting the coiled configuration. The reel axle may include fixed and movable elements thereof, operatively interconnected to one another and configured for applying a clamping force to the reel support along the axis of rotation, to thereby urge the reel support into frictional contact with the hub, in a manner causing resistance to rotation of the hub and the coiled configuration mounted thereupon, about the axis of rotation. At least one of the fixed and movable elements of the reel axle may be selectively movable along the axis of rotation, with respect to the other of the fixed and movable elements, for selectively adjusting the clamping force applied to the reel support and, thereby, the frictional contact of the reel support with the hub disposed within the coiled configuration of the thermoplastic adhesive dispensing tape.

In some forms of the invention, the base of the wire frame may have a transverse width that is substantially wider than the transverse width of the carrier tape, such that the base provides stability in the transverse direction. The transverse width of the base may fall within the range of two to ten times the transverse width of the carrier tape.

In some forms of the invention, the wire frame is formed from a single length of wire. The single length of wire may include first and second legs thereof, extending upward from the base and configured to form the reel support and the anvil support. The first and second legs of the wire frame may also then descend from the anvil support, and include respective distal ends thereof which are fixedly attached to the base.

A dispensing apparatus, according to the invention, for dispensing pressure-sensitive adhesive segments from a longitudinally extending flexible carrier tape, may take the form of a combination of a pressure-sensitive adhesive tape including the flexible carrier tape and adhesive segments, with a dispenser having a substantially rigid wire frame and an anvil, according to the invention.

The invention may take various forms, of a method and/or apparatus for making and/or using a dispensing apparatus, according to the invention.

Other aspects, objects and advantages of the invention will be apparent from the following detailed description taken in conjunction with the accompanying drawings.

### DESCRIPTION OF THE DRAWINGS

The accompanying drawings illustrate several aspects of the present invention and, together with the description, serve to explain the principles of the invention. In the drawings:

FIG. 1 is a perspective illustration of an exemplary embodiment of a dispensing apparatus, according to the invention;

FIG. 2 is a cross-section illustrating the construction and attachment of an anvil of a dispenser of the exemplary embodiment of the dispensing apparatus, according to the invention, shown in FIG. 1;

FIG. 3 is an enlarged partial cross-section through a braking apparatus, of the exemplary embodiment of the dispensing apparatus shown in FIG. 1;

FIG. 4 is an orthographic side view of the dispenser of the exemplary embodiment of the dispensing apparatus shown in FIG. 1;

FIG. 5 is an orthographic top view of the dispenser of the exemplary embodiment of the dispensing apparatus shown in FIG. 1; and

FIG. 6 is an orthographic illustration showing operation of the exemplary embodiment of the dispensing apparatus of FIG. 1, according to the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE PREFERRED EMBODIMENT

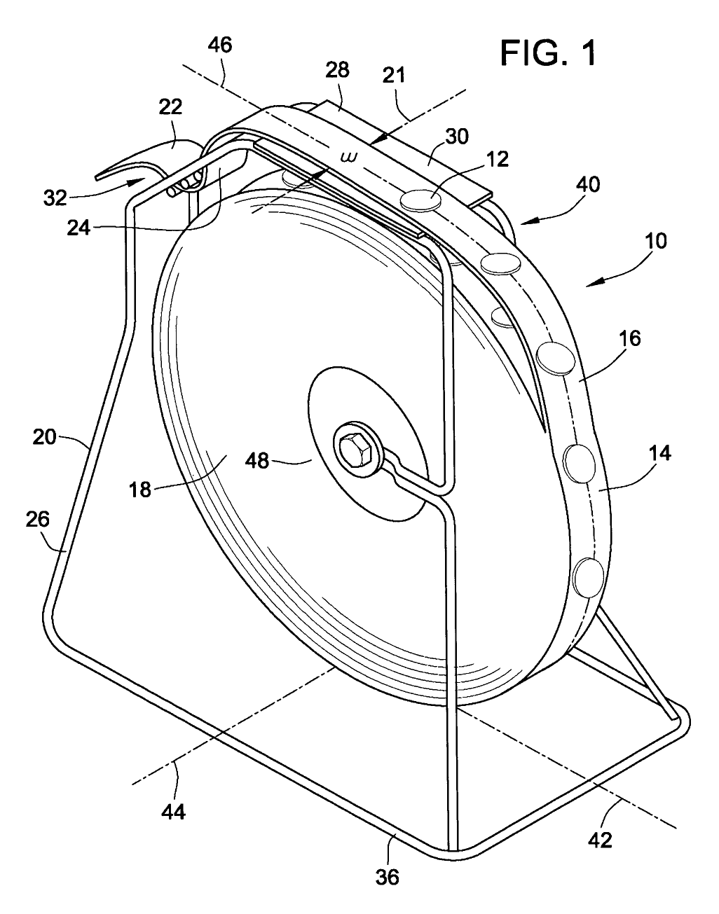

FIG. 1 shows an exemplary embodiment of a dispensing apparatus 10 for dispensing pressure-sensitive adhesive segments 12 from a flexible carrier tape 14, of a pressure-sensitive adhesive dispensing tape 16 which includes the flexible carrier tape 14 and the adhesive segments 12. The exemplary embodiment of the dispensing apparatus 10 includes a coiled configuration 18 of the pressure-sensitive adhesive dispensing tape 16, in combination with a dispenser 20, with both the coiled configuration 18 and the dispenser 20 being described in greater detail below.

The carrier tape 14 has a transverse tape width W, extending along a transverse axis 21 of the carrier tape 14, and opposed first and second release surfaces 22, 24 of the carrier tape 14, with the adhesive segments 12 being arrayed longitudinally along the first release surface 22. As disclosed in the aforementioned commonly assigned patent to Downs, the carrier strip is fabricated in such a manner that a release material is selectively applied on the opposed first and second surfaces 22 and 24, so that the first surface 22 of the carrier tape 14 provides less release than the second surface 24. By virtue of this arrangement, the adhesive segments 12 will adhere more tightly to the first surface of the carrier tape 14 than they do to the second surface of the carrier tape 14, in such a manner that, as the pressure-sensitive adhesive dispensing tape 16 is unwound from the coiled configuration 18, the adhesive segments 12 remain attached to the first surface 22 of the carrier tape 14, and separate from the second surface 24 of the carrier tape 14, in the manner depicted in FIG. 1. The adhesive segments 12 are arrayed longitudinally along the first release surface 22 of the carrier tape 14, in such a manner that the adhesive segments 12 may be positioned, one at a time, for removal from the carrier tape 14.

The dispenser 20 includes a substantially rigid wire frame 26, and an anvil 28, having a tape contact surface 30 thereof which is adapted for contacting the second surface 24 of the carrier tape 14. The dispenser further includes a guide 32 for receiving the carrier tape 14 after the adhesive segments 12 have been removed, and a braking apparatus 34.

The dispenser 20 includes a substantially rigid wire frame 26, and an anvil 28, having a tape contact surface 30 thereof which is adapted for contacting the second surface 24 of the carrier tape 14. The dispenser further includes a guide 32 for receiving the carrier tape 14 after the adhesive segments 12 have been removed, and a braking apparatus 34.

The reel support 38, of the wire frame 26, is disposed above the base 36 of the wire frame 26, when the base 26 is resting on a horizontal surface, for holding the coiled configuration 18 of the pressure-sensitive adhesive dispensing tape 16 suspended within the dispenser 20, with the first surface 22 of the carrier tape 14 facing outward from the coil 18. The reel support 34 further defines a substantially transversely oriented axis of rotation 48 of the coiled configuration 18 of the pressure-sensitive adhesive dispensing tape 16.

The anvil support 40 of the wire frame 26 is disposed above the reel support 34, and has the anvil 28 attached thereto, with the tape contact surface 30 of the anvil 28 facing upward and oriented substantially horizontally i.e. parallel to the base 36, when the base 36 of the wire frame 26 is resting on a horizontal surface.

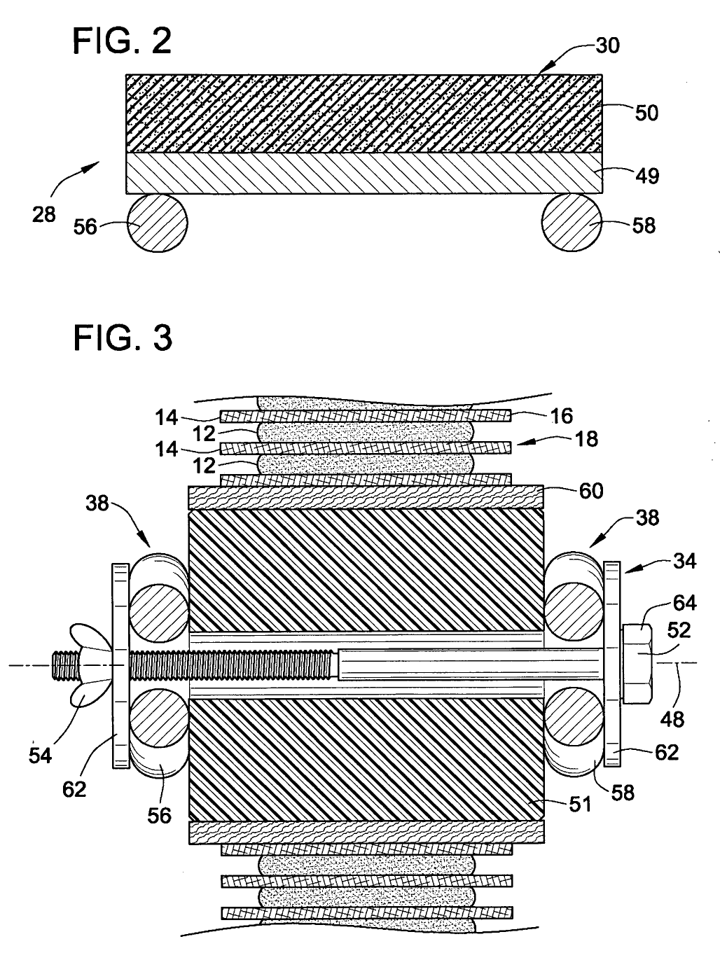

As shown in FIG. 2, the anvil 28, of the exemplary embodiment of the invention, includes a resilient pad 50 of an elastomeric foam, or other appropriate material, mounted upon a rigid anvil base plate 49, and bearing against and/or defining the tape contact surface 30 of the anvil 28, with the tape contact surface 30 of the anvil being formed of a material having a low coefficient of friction, to thereby allow the second surface 24 of the carrier tape 14 to slide readily across the anvil 28.

As shown in FIG. 3, the braking apparatus 34 of the exemplary embodiment of the invention is operatively connected to the reel support 38, for resisting rotation of the coiled configuration 18 of the pressure-sensitive adhesive dispensing tape 16 about the axis of rotation 48. The braking apparatus 34, in the exemplary embodiment thereof, includes a hub 51, and a reel axle having a fixed element, in the form of a bolt 52 and a movable element, in the form of a wing nut 54 which is threaded onto a threaded end of the bolt 52. The bolt 52, of the reel axle of the braking device 34, extends through a central bore in the hub 51 along the axis of rotation 48, through first and second portions 56, 58 of the reel support 38 which are disposed adjacent opposite axial ends of the hub 51, which is inserted into a cylindrical core 60, upon which the pressure-sensitive adhesive dispensing tape 16 is wound to form the coiled configuration 18. The combination of the core 60 and the coil 18 of tape 16 wound thereupon, forming a reel of the pressure-sensitive adhesive dispensing tape 16. The braking apparatus 34 also includes a pair of washers 62 disposed between the first and second portions 56, 58 of the reel support 38 and the head 64 of the bolt 52 and the wing nut 54 respectively.

The core 60 of the reel of pressure-sensitive adhesive dispensing tape 16 fits tight enough onto the hub 51, that the core 60 (and the coiled configuration 18 wound onto the core 60) rotate together about the axis of rotation 48.

By virtue of the arrangement of the various components of the exemplary embodiment of the braking apparatus 34, with respect to the reel support 38 and coiled configuration 18, and further by virtue of the threaded connection between the bolt 52 and wing nut 54, a clamping force may be applied to the reel support 38, along the axis of rotation 48, to thereby urge the first and second portions 56, 58 of the reel support 38 into frictional contact with the hub 51, in a manner causing resistance to rotation of the coiled configuration 18 about the axis of rotation 48. By virtue of the fact that the wing nut 34 is selectively movable along the axis of rotation 48, with respect to the bolt 52, using the threaded connection between the bolt 52 and wing nut 54 for selectively adjusting the clamping force applied to the reel support 38, the braking apparatus 34 allows selective adjustment of the degree of frictional contact between the reel support 38 and the hub 51. By adjusting the clamping force, the resistance to rotation of the coiled configuration 18 in the dispenser 20 can be conveniently adjusted to a desired level.

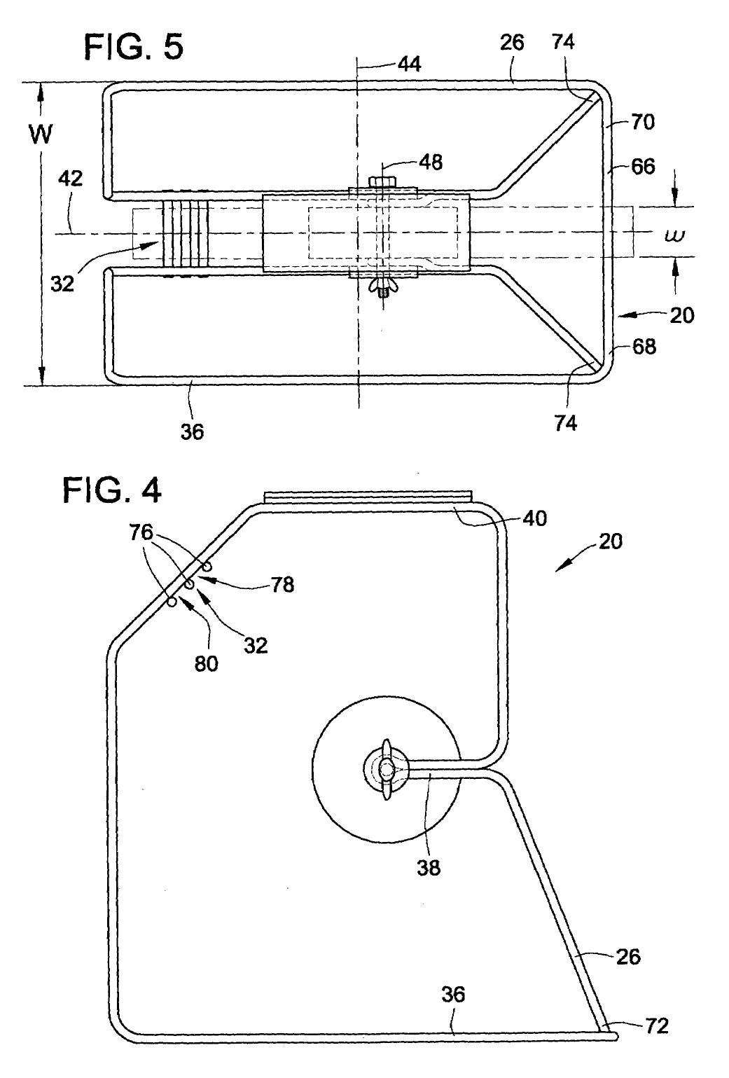

As shown in FIGS. 1, 4, and 5, the wire frame 26, of the exemplary embodiment of the dispenser 20, is formed from a single length 66 of wire, including first and second legs 68, 70 thereof extending upward from the base 36 and configured in a generally symmetrical and mirror-imaged fashion to form the reel support 38 and the anvil support 40, before descending downward from the anvil support 40. The respective distal ends 72, 74 of the first and second legs 68, 70 of the single length of wire 66 are fixedly attached to the base 36 of the wire frame, to thereby form a substantially rigid structure.

In the exemplary embodiment of the invention, the distal ends 72, 74 of the single length of wire 66 forming the wire frame 26 are attached to the base 36 by a process such as welding or brazing. In similar fashion, the metallic plate portion 49, of the anvil 28 is welded or brazed to the first and second portions 56, 58 of the anvil support 40, with the first and second portions 56, 58 of the anvil support 40 being respectively formed by the first and second legs 68, 70 of the wire frame 26.

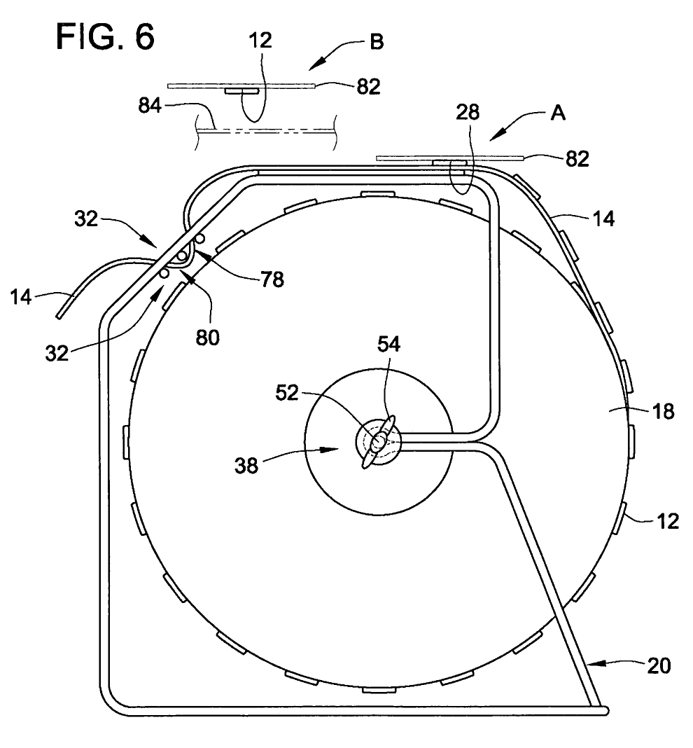

In the exemplary embodiment of the dispenser 20, the guide 32 takes the form of three short lengths of wire 76, which extend across and are welded the first and second legs 68, 70, of the wire frame 26, to form a pair of gaps 78, 80, through which the distal end of the carrier tape 14 may be fed, in the manner illustrated in FIG. 6, for restraining the distal end of the carrier tape 14 after the adhesive segments 12 have been removed.

As shown in FIG. 5, the base 36 of the wire frame 26, in the exemplary embodiment of the dispenser 26, has a transverse width W that is substantially wider than the transverse width w of the carrier tape 14, so that the base 36 provides stability for the dispenser in the transverse direction.

Operation of the exemplary embodiment of the dispensing apparatus 10 is illustrated in FIG. 6. The coiled configuration 18 is supported in the dispenser 20 on the bolt 52, with the adhesive segments 12 facing outward, and the carrier tape 14 being fed upward off of the coiled configuration 18 and across the anvil 28, with the distal end of the carrier tape 14 being fed through the gaps 78, 80 of the guide 32. The wing nut 54 of the braking device 38 is tightened to provide a desired degree of frictional force against the coiled configuration 18, in such a manner that the braking device 38 and guide 32, in combination, preclude uncontrolled and undesired unwinding of the coiled configuration 18.

By pulling on the distal end of the carrier tape 14, a first one of the adhesive segments 12 is positioned above the anvil 28. A credit card 82, or the like, is then pressed downward against the first one of the adhesive segments 12, as shown at position A in FIG. 6, and is then lifted away, as shown at position B in FIG. 6. The release agent is selectively applied to the first surface of the carrier tape 14 in such a manner that the first one of the adhesive segments 12 will adhere more strongly to the card 82, than it does to the carrier tape 14, thereby allowing the card 82 to pull the first one of the adhesive segments 12 free of the carrier tape 14. The card 82 is then positioned over and pressed against a carrier document 84, such as a card or letter, or the like, to bond the pressure sensitive pressure-sensitive adhesive segment 12, on the back of the card 82 to the carrier document 84. The distal end of the carrier tape 14 is then pulled through the guide 32, a distance sufficient to bring the next one of the adhesive segments 12 into position on the anvil 28, for subsequent transfer of the next adhesive segment 12 to another card 82.

Those having skill in the art will recognize that the adhesive segment dispensing apparatus, of the present invention, provides a number of advantages over prior dispensing apparatuses and methods. The overall construction, and materials utilized in forming the dispenser, according to the invention, results in a dispenser which is significantly more rigid, stable, and durable than prior dispensers. The braking apparatus of the present invention, provides significantly enhanced control of the coiled configuration of the pressure-sensitive adhesive dispensing tape, than did prior dispensing apparatuses and methods. The anvil of the present invention provides significantly improved support of the carrier tape during application of force to remove the pressure-sensitive adhesive segments from the carrier tape 14. The rigid plate portion of the anvil, formed from metal, plastic, or another appropriately rigid material provides improved resistance to excessive application of force by inexperienced or careless operators, and the resilient pad and low coefficient tape contact surface of an anvil, according to the invention, facilitate movement of the carrier tape across the anvil, while providing for consistently reliable rapid bonding of the adhesive segments onto a card or the like.

Those having skill in the art will also recognize, that although the invention has been described herein in terms of particular exemplary embodiments, the invention may be practiced in a variety of other forms, within the scope of the invention. For example, a braking device, in a dispenser according to the invention, may take a significantly different form than the exemplary embodiment of the braking apparatus described above, and may be eliminated in certain alternate embodiments of the invention.

The wire frame, in a dispenser according to the invention, need not be made from a single piece of wire, as disclosed above in relation to the exemplary embodiment. In other embodiments of the invention, it may be desirable to form a wire frame from multiple pieces of wire. The wire frame and its component parts, including the base, reel support and anvil support, may have shapes which differ significantly from the exemplary embodiment described herein.

In similar fashion, in other embodiments of the invention, it may be desirable to include elements formed from sheet material to provide various elements and/or connections between various portions of a wire frame, according to the invention.

The anvil and guide, in alternate embodiments of the invention, may take a variety of other forms, which are mechanically or otherwise appropriately joined to the wire frame. The distal ends of the wire frame may be attached to the base of a wire frame, according to the invention, by other means, such as through a mechanical joint, or adhesive bonding, rather than being welded or brazed, as in the exemplary embodiment.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. An apparatus for dispensing pressure-sensitive adhesive segments from a flexible carrier tape of a pressure-sensitive adhesive tape including the flexible carrier tape and the adhesive segments, the carrier tape having a transverse tape width and opposed first and second release surfaces of the tape, the adhesive segments being arrayed longitudinally along the first release surface, the dispensing apparatus comprising:
a dispenser, including a substantially rigid wire frame and an anvil having a tape contact surface thereof adapted for contacting the second surface of the carrier tape;
the wire frame of the dispenser including a base, a reel support, and an anvil support;
the base of the wire frame being shaped for resting on a horizontal surface and defining longitudinal and transverse frame axes extending substantially parallel to the longitudinal and transverse axes of the carrier tape;
the reel support of the wire frame being disposed above the base, when the base is resting on a horizontal surface, for holding the pressure-sensitive adhesive dispensing tape in a coiled configuration with the first surface of the carrier tape facing outward from the coil;
the anvil support of the wire frame being disposed above the reel support and having the anvil attached thereto, with the tape contact surface of the anvil facing upward and oriented substantially horizontally, when the base of the wire frame is resting on a horizontal surface.

2. An apparatus as defined in claim 1, wherein the dispenser further comprises:
a guide for receiving the carrier tape after the adhesive segments have been removed.

3. An apparatus as defined in claim 1, wherein the anvil further comprises:
a resilient pad bearing against and/or defining the tape contact surface of the anvil, and the tape contact surface is formed of a material having a low coefficient of friction.

4. An apparatus as defined in claim 1, further comprising:
a reel axle operatively attached to the reel support and defining a substantially transversely oriented axis of rotation of the coiled configuration of the pressure-sensitive adhesive dispensing tape.

5. An apparatus as defined in claim 1, wherein the reel support defines a substantially transversely oriented axis of rotation of the coiled configuration of the pressure-sensitive adhesive dispensing tape, and the apparatus further comprises:
a braking apparatus operatively connected to the reel support, for resisting rotation of the coiled configuration of the pressure-sensitive adhesive dispensing tape about the axis of rotation.

6. An apparatus as defined in claim 4, wherein the braking apparatus comprises
a rotatable hub adapted for extending through and being rotationally fixed to the coiled configuration of the pressure-sensitive adhesive dispensing tape; and
a reel axle, extending along the axis of rotation through the reel support and the hub, for supporting the coiled configuration;
with the reel axle including fixed and movable elements thereof operatively interconnected to one another and configured for applying a clamping force to the reel support along the axis of rotation, to thereby urge the reel support into frictional contact with the hub in a manner causing resistance to rotation of the coiled configuration of the pressure-sensitive adhesive dispensing tape mounted on the hub about the axis of rotation.

7. An apparatus as defined in claim 6, wherein at least one the fixed and movable elements of the reel axle is selectively movable along the axis of rotation, with respect to the other of the fixed and movable elements, for selectively adjusting the clamping force applied to the reel support and, thereby, the frictional contact of the reel support with the hub.

8. An apparatus as defined in claim 1, wherein the base has a transverse width that is substantially wider than the transverse width of the carrier tape, such that the base provides stability in the transverse direction.

9. An apparatus as defined in claim 8, wherein the transverse width of the base is within the range of two to ten times the transverse width of the carrier tape.

10. An apparatus as defined in claim 1, wherein the wire frame is formed from a single length of wire.

11. An apparatus as defined in claim 10, wherein the wire frame includes first and second legs thereof extending upward from the base and configured to form the reel support and the anvil support.

12. An apparatus as defined in claim 10, wherein the first and second legs of the wire frame descend from the anvil support, and include respective distal ends thereof which are fixedly attached to the base.

13. An apparatus for dispensing pressure-sensitive adhesive segments from a longitudinally extending flexible carrier tape, the dispensing apparatus comprising, in combination:
a pressure-sensitive adhesive tape, including the flexible carrier tape and the adhesive segments, the carrier tape having a transverse tape width and opposed first and second release surfaces of the tape, the adhesive segments being arrayed longitudinally along the first release surface; and
a dispenser, including a substantially rigid wire frame and an anvil having a tape contact surface thereof adapted for contacting the second surface of the carrier tape;
the wire frame of the dispenser including a base, a reel support, and an anvil support;
the base of the wire frame being shaped for resting on a horizontal surface and defining longitudinal and transverse frame axes extending substantially parallel to the longitudinal and transverse axes of the carrier tape;
the reel support of the wire frame being disposed above the base, when the base is resting on a horizontal surface, for holding the pressure-sensitive adhesive dispensing tape in a coiled configuration with the first surface of the carrier tape facing outward from the coil;
the anvil support of the wire frame being disposed above the reel support and having the anvil attached thereto, with the tape contact surface of the anvil facing upward and oriented substantially horizontally, when the base of the wire frame is resting on a horizontal surface.

14. An apparatus as defined in claim 11, wherein the dispenser further comprises:
a guide for receiving the carrier tape after the adhesive segments have been removed.

15. An apparatus as defined in claim 11, wherein the anvil further comprises:
a resilient pad bearing against and/or defining the tape contact surface of anvil, and the tape contact surface is formed of a material having a low coefficient of friction.

16. An apparatus as defined in claim 11, further comprising:
a reel axle operatively attached to the reel support and defining a substantially transversely oriented axis of rotation of the coiled configuration of the pressure-sensitive adhesive dispensing tape.

17. An apparatus as defined in claim 11, wherein the reel support defines a substantially transversely oriented axis of rotation of the coiled configuration of the pressure-sensitive adhesive dispensing tape, and the apparatus further comprises:
a braking apparatus operatively connected between the reel support and the coiled configuration of the pressure-sensitive adhesive dispensing tape, for resisting rotation of the coiled configuration of the pressure-sensitive adhesive dispensing tape about the axis of rotation.

18. An apparatus as defined in claim 17, wherein the braking apparatus comprises:
a rotatable hub adapted for extending through and being rotationally fixed to the coiled configuration of the pressure-sensitive adhesive dispensing tape; and
a reel axle, extending along the axis of rotation through the reel support and the hub, for supporting the coiled configuration;
with the reel axle including fixed and movable elements thereof operatively interconnected to one another and configured for applying a clamping force to the reel support along the axis of rotation, to thereby urge the reel support into frictional contact with the hub in a manner causing resistance to rotation of the coiled configuration of the pressure-sensitive adhesive dispensing tape mounted on the hub about the axis of rotation.

19. An apparatus as defined in claim 18, wherein at least one the fixed and movable elements of the reel axle is selectively movable along the axis of rotation, with respect to the other of the fixed and movable elements, for selectively adjusting the clamping force applied to the reel support and, thereby, the frictional contact of the reel support with the hub.

20. An apparatus, for dispensing pressure-sensitive adhesive segments from a flexible carrier tape of a pressure-sensitive adhesive tape including the flexible carrier tape and the adhesive segments, the carrier tape having a transverse tape width and opposed first and second release surfaces of the tape, the adhesive segments being arrayed longitudinally along the first release surface, the dispensing apparatus comprising:
a dispenser, including a substantially rigid wire frame, an anvil having a tape contact surface thereof adapted for contacting the second surface of the carrier tape, a guide for receiving the carrier tape after the adhesive segments have been removed, and a braking apparatus;
the wire frame of the dispenser including a base, a reel support, and an anvil support;
the base of the wire frame being shaped for resting on a horizontal surface and defining longitudinal and transverse frame axes extending substantially parallel to the longitudinal and transverse axes of the carrier tape;
the reel support of the wire frame being disposed above the base, when the base is resting on a horizontal surface, for holding the pressure-sensitive adhesive dispensing tape in a coiled configuration with the first surface of the carrier tape facing outward from the coil;
the reel support further defining a substantially transversely oriented axis of rotation of the coiled configuration of the pressure-sensitive adhesive dispensing tape,
the anvil support of the wire frame being disposed above the reel support and having the anvil attached thereto, with the tape contact surface of the anvil facing upward and oriented substantially horizontally, when the base of the wire frame is resting on a horizontal surface;
the anvil having a resilient pad bearing against and/or defining the tape contact surface of anvil, with the tape contact surface of the anvil being formed of a material having a low coefficient of friction;
the braking apparatus being operatively connected to the reel support, for resisting rotation of the coiled configuration of the pressure-sensitive adhesive dispensing tape about the axis of rotation, and including a hub and reel axle;
the hub of the braking device being rotatably mounted on the reel axle, and adapted for extending through and being rotationally fixed to the coiled configuration of pressure-sensitive adhesive dispensing tape;
the reel axle of the braking device, extending along the axis of rotation through the reel support and the hub for supporting the coiled configuration when the coiled configuration is installed in the dispensing apparatus;
the reel axle of the braking device including fixed and movable elements thereof operatively interconnected to one another and configured for applying a clamping force to the reel support along the axis of rotation, to thereby urge the reel support into frictional contact with the hub in a manner causing resistance to rotation of the hub and the coiled configuration of the pressure-sensitive adhesive dispensing tape about the axis of rotation, with at least one the fixed and movable elements of the reel axle being selectively movable along the axis of rotation, with respect to the other of the fixed and movable elements, for selectively adjusting the clamping force applied to the reel support and, thereby, the frictional contact of the reel support with the hub;
the wire frame being formed from a single length of wire, including first and second legs thereof extending upward from the base and configured to form the reel support and the anvil support, the first and second legs of the wire frame descending from the anvil support and having respective distal ends thereof which are fixedly attached to the base.

21. An apparatus as defined in claim 20, wherein the base has a transverse width that is substantially wider than the transverse width of the carrier tape, such that the base provides stability in the transverse direction.
